(19) United States
(12) Patent Application Publication
(10) Pub. No.: US 2005/0268110 A1
(43) Pub. Date: Dec. 1, 2005

(54) Authentication token

(76) Inventor: Will Shatford, Pasadena, CA (US)

Correspondence Address: DRINKER BIDDLE & REATH;ATTN: INTELLECTUAL PROPERTY GROUP, ONE LOGAN SQUARE, 18TH AND CHERRY STREETS, PHILADELPHIA, PA, 19103-6996, US

(21) Appl. No.: 11/136,108

(22) Filed: May 24, 2005

Related U.S. Application Data
(60) Provisional application No. 60/574,367, filed on May 25, 2004.

(51) Int. Cl. H04L 9/00

(52) U.S. Cl. 713/185

(57) ABSTRACT

A multi-function token comprising a body with a front and rear face, a microchip embedded in the body, an interface to the microchip on the front face of the body, and a display on the front face of said body, wherein an authentication code is optically output via the display.

### RELATED APPLICATION

The present invention claims priority to U.S. Provisional Application No. 60/574,367, filed on May 25, 2004, which is fully incorporated herein by reference.

### FIELD

The present invention relates generally to the field of secure access to network systems, and, more specifically, to an authentication token to control system access.

### BACKGROUND

As a result of the ever increasing use of electronic systems for handling sensitive information (e.g., computerized banking, secure networks, etc.), the need to provide adequate security is greater than at any time prior to today. Assuring that access to such systems will be restricted to only those properly authorized is an essential element of today's networks. As a result, several methods of restricting access and verifying user identity have been developed.

One such device that has been used to aid in maintaining security to both public and private networks is a key fob. A key fob is a type of security device or token that has a built-in authentication mechanism. For example, a typical key fob is a small portable device that provides authentication using an authentication code. The key fob generates the authentication code and displays the code to the user via a display located on the key fob. The user can enter the code into the system, which recognizes the access code generated and provides system access. Typically, a key fob is used in conjunction with a password or personal identification number (PIN). This helps to ensure that the authorized user is in possession of the key fob. By requiring both the key fob and the PIN, a two-factor authentication process is created.

Key fob devices are typically stand-alone devices, meaning that the key fob device operates by itself without needing a special reader to retrieve the information. The information is provided via a display located on the key fob itself. However, because key fob devices typically contain a display output, they are typically slightly larger than many individuals prefer to carry. They are typically designed to be attached to a key chain and carried in one's pocket, but because of their size and thickness, they are typically not conducive to carrying in one's wallet.

Another type of device that has been used to provide user authentication in conjunction with network systems is a smart card. Smart cards are plastic devices that typically resemble credit cards. A microchip is typically embedded within the card. Information is stored on the microchip that enables the smart card to be used for authentication purposes. For example, the smart card can interact with a card reader to exchange data (e.g., an encrypted key or other challenge/response process) to provide user authentication. Similar to key fob devices, smart cards may often be used in combination with a PIN to provide an additional layer of security. By requiring a user to enter a PIN, the probability that the card is being used by someone other than the authorized user is reduced.

Smart cards are typically thinner than key fob devices, and thus are more conducive to carrying in one's wallet. Smart cards, however, are not stand alone devices. Smart cards require special readers into which the smart card is inserted in order to perform the authentication process.

Prior to the present invention, a need existed for an authentication device that can operate as a stand-alone device without the form factor limitations of key fob devices. The present invention fulfills this need, among others.

### SUMMARY

An multi-function token is advantageously provided for user authentication that can function both in a stand-alone mode or in conjunction with a reader.

In an exemplary embodiment, the token comprises a body with a front and rear face, a microchip embedded in the body, an interface to the microchip on the front face of the body, and a display on the front face of said body. An authentication code is optically output via the display.

In an exemplary embodiment, the token is the size of a standard credit card and includes a pseudorandom number generator. The authentication code may be based, all or in part, on the numbers generated by the pseudorandom number generator. Additionally, the token may include one or more magnetic stripes for providing additional functions, such as credit or debit card functions.

Additional objects, advantages, and novel features of the invention will be set forth in part in the description, examples, and figures which follow, all of which are intended to be for illustrative purposes only, and not intended in any way to limit the invention, and in part will become apparent to the skilled in the art on examination of the following, or may be learned by practice of the invention.

### BRIEF DESCRIPTION OF THE DRAWINGS

For the purpose of illustrating the invention, there is shown in the drawings one exemplary implementation; however, it is understood that this invention is not limited to the precise arrangements and instrumentalities shown.

FIG. 1 illustrates the front side of a device in accordance with an exemplary embodiment of the present invention.

FIG. 2 illustrates the rear side of a device in accordance with an exemplary embodiment of the present invention.

### DETAILED DESCRIPTION OF CERTAIN PREFERRED EMBODIMENTS

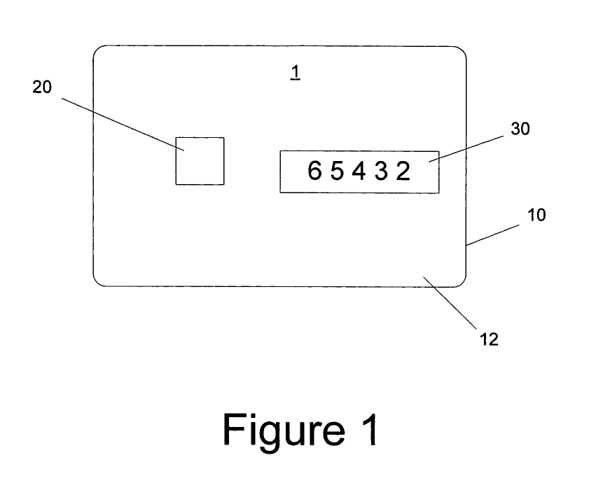

In the exemplary embodiment of the present invention, an multi-function authentication token is provided. Referring to FIG. 1, a front view of a token 1 in accordance with the exemplary embodiment of the present invention is shown. Token 1 comprises a body 10 formed from a lightweight, durable plastic materials such as are commonly used in the manufacture of credit cards. Various materials are well known to those of skill in the art. Body 10 illustrated in FIG. 1 is in the form of a standard credit card, typically having length and width dimensions of approximately 86 mm×54 mm. In an exemplary embodiment, token 10 is less than 1 mm in thickness, typically measuring approximately 0.8 mm thick. This configuration of body 10 allows token 1 to be easily carried in a wallet of a user. It is understood, however, that other sizes and forms may be used. For example, body 10 could be constructed in a larger form that is worn as a badge by the user, or in a smaller key-chain size form.

A smart card interface pad 20 resides on a front face 12 of body 10. Smart card interface pad 20 provides an interface to an embedded microchip (not shown in FIG. 1) that resides within body 10. Interface pad 20 allows for access to the microchip by a reader device. Smart cards are typically used in a manner similar to credit cards. They are, however, more secure than credit cards, which is desirable in situations where the ability to connect to the authentication network of the credit card provider is unreliable. Smart cards improve reliability because when a smart card is placed in a smart card reader and the user is asked to enter a PIN number, the reader can verify the PIN without the need to connect to the credit card network. The PIN is stored in the microchip and can be verified by accessing the microchip via interface 20. Additionally, power can be provided to the microchip via interface 20 while token 1 is in the reader. When token 1 is not located in the reader, the microchip is typically powered by a small flexible power source, for example, a thin-film Lithium Ion battery sufficiently small enough to fit on or within token 1.

The embedded microchip in body 10 provides a dual purpose. First, the microchip may provide any of the functions currently associated with smart cards. For example, smart cards have been used to provide personal medical information for use at doctor's offices or hospitals, to track transit pass information for subways, trains, and buses, to provide calling card features, etc. Additionally, token 1 may be used to authenticate user identity when used in conjunction with a reader apparatus in the manner typically used by existing smart cards.

In addition to providing smart card functions, the microchip embedded in body 10 is used to operate a pseudorandom number generator. The pseudorandom number generator may be based on various parameters. For example, the pseudorandom number generator may be time-based, transaction-based, environmentally-based, based on information received via wireless RF transmission, or any combination of these. Additional parameters for operating a pseudorandom number generator are known to one of skill in the art and could be incorporated into token 1. The microchip also may be programmed to alter and/or update the pseudorandom number generator. Access to the microchip for programming is provided via interface pad 20. Interface pad 20 is affixed to the token 1 in any area where electrical contact can be made, or alternatively, is located in an area where wireless signals can be received (e.g., interface pad 20 can further include a built-in antenna).

The generated number is displayed on a display 30 located on front face 15 of body 10. Display 30 produces an optical output, e.g., the generated number, that can be read by the card holder. Display 30 is typically a liquid crystal display (LCD) similar to the types currently used in small applications such as calculators and watches. Display 30 is typically powered by a small flexible power source, typically a thin-film Lithium Ion battery, which can be the same power source used to power the embedded microchip or could be an additional secondary power source. In the embodiment illustrated in FIG. 1, display 30 is a five digit display; however, it is appreciated that LCD displays having the capability to output various numbers of digits or other characters may be used.

Display 30 enables token 1 to be used in a stand-alone mode. Token 1 can output an authentication code via display 30, which can be used as a passcode for login and identification. The authentication code can also be communicated directly via a reader or via wireless transmission. Because the authentication code is generated by token 1 independent from any other device in accordance with a predetermined criteria, it can be used as a passcode without requiring a special reader apparatus. In an exemplary embodiment, the authentication code is generated by the pseudorandom number generator based on information stored in the microchip. Alternatively, the authentication code may be generated by the pseudorandom number generator based on information provided via interface pad 20 or via wireless connection. This process is typically referred to as a challenge/response. The authentication code can be based solely on the received information or can be based on a combination of the received information and information stored on the microchip.

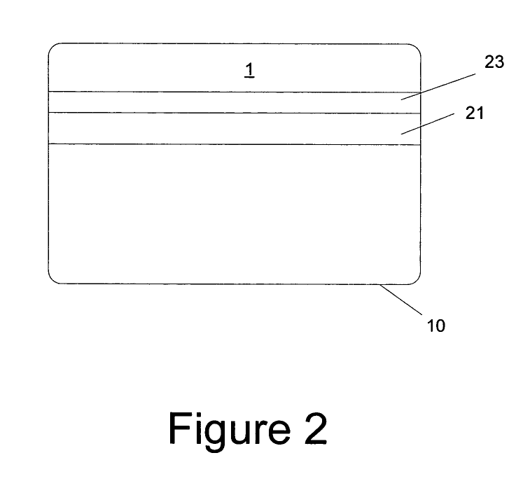

Additionally, in an exemplary embodiment, token 1 includes one or more magnetic strips. Referring to FIG. 2, a first magnetic stripe 21 and a second magnetic stripe 23 are shown on the rear side of body 10. Magnetic stripes 21, 23 can be of varying widths and contain one or more tracks. The application of magnetic stripes to a plastic substrate is known in the art and thus is not discussed in detail herein. The magnetic stripes enable the token to be used as a standard credit or debit card.

The exemplary embodiment of the present invention allows for a multi-purpose authentication token to be used to both provide system access as well as to provide smart card and magnetic stripe card functions. A variety of modifications to the embodiment described will be apparent to those skilled in the art from the disclosure provided herein. Thus, the present invention may be embodied in other specific forms without departing from the spirit or essential attributes thereof and, accordingly, reference should be made to the appended claims, rather than to the foregoing specification, as indicating the scope of the invention.

1. A multi-function token comprising:
a body having at least one face;
a microchip embedded in said body;
an interface to said microchip on a face of said body; and
a display on a face of said body,
wherein an authentication code is optically output via said display.

2. The token as set forth in claim 1, further comprising:
a magnetic stripe on a face of said body.

3. The token as set forth in claim 2, wherein said body has a front face and a rear face and said stripe is on said rear face of said body.

4. The token as set forth in claim 1, wherein said body has a front face and a rear face and said interface is on said front face.

5. The token as set forth in claim 1, wherein said body has a front face and a rear face and said display is on said front face.

6. The token as set forth in claim 1, further comprising:
a pseudorandom number generator.

7. The token as set forth in claim 6, wherein said pseudorandom number generator resides within said microchip.

8. The token as set forth in claim 6, wherein said authentication code is based in part on pseudorandom number generator.

9. The token as set forth in claim 1, wherein said interface is capable of receiving wireless communication.

10. The token as set forth in claim 9, wherein said authentication code is based in part on said wireless communication.

11. The token as set forth in claim 9, wherein said authentication code is based on a combination of information stored in said microchip and information input via said interface.

12. The token as set forth in claim 6, wherein said authentication code is based in part on information input to said token via said interface.

13. The token as set forth in claim 12, wherein said authentication code is based on a combination of information stored in said microchip and information input via said interface.

14. The token as set forth in claim 1, wherein said body is in the form of a standard credit card.

15. The token as set forth in claim 14, wherein said body has physical dimensions of approximately 86 mm×54 mm×0.8 mm.

16. The token set forth in claim 1, wherein said body has a thickness of less than one millimeter.

17. A method for user authentication comprising:
providing a multi-function token having a body with at least one face, wherein the token comprises:
a microchip embedded in said body;
an interface to said microchip on a face of said body; and
a display on a face of said body;
generating an authentication code on said token; and
outputting said authentication code via said display.

18. The method as set forth in claim 17, wherein said generating step comprises using a pseudorandom number generator to generate said authorization code.

19. The method as set forth in claim 17, wherein said generating step comprises using a wireless communication to generate said authorization code.
